(19) United States
(12) Patent Application Publication
(10) Pub. No.: US 2001/0011222 A1
(43) Pub. Date: Aug. 2, 2001

(54) INTEGRATED PROCUREMENT MANAGEMENT SYSTEM USING PUBLIC COMPUTER NETWORK

(76) Inventors: ANDREW W. MCLAUCHLIN, RESTON, VA (US); GREGG MOSSBURG, CENTREVILLE, VA (US)

Correspondence Address: STAAS & HALSEY, 700 ELEVENTH STREET N W, SUITE 500, WASHINGTON, DC, 20001

(21) Appl. No.: 09/220,380

(22) Filed: Dec. 24, 1998

(51) Int. Cl. G06F 17/60

(52) U.S. Cl. 705/1; 709/203

(57) ABSTRACT

Access to procurement (purchasing and contract) data is provided to many users by a system that connects a core procurement system used by procurement professionals in a procuring agency to a public computer network like the Internet. At least one Web/application server connected to the core procurement system by a LAN or WAN provides access to non-procurement personnel in the procuring agency, non-agency personnel in the same organization, vendors, grantees and others, based on security procedures established by an authorized procurement officer in the procuring agency. Users of the system connected via the Internet use Java-enabled Web browsers to create, receive and send procurement documents and data via XML formatted documents. Field buyers connected via a mobile link use portable computers to send and receive similar data. Each user can access a reference library of information sources, such as the FAR, DOL wage rates, etc., in XML format to obtain procurement regulations and required data elements. Procurement documents and data include, but are not limited to, agreements, contracts, grants, solicitations, bids, catalog purchases, announcements, approvals, vendor profile and performance data, interagency agreements, and acquisition plans. All resulting procurement management data is integrated into the core procurement system, where procurement managers exert managerial procurement controls and generate required reports.

### BACKGROUND OF THE INVENTION

1. Field of the Invention

The present invention is directed to an integrated, collaborative procurement system and, more particularly, to a system for widely distributed users to exchange data and documents related to contractual relationships and reference data from standard information sources in a self-describing data format.

2. Description of the Related Art

Just as there are many types of agreements or contractual relationships between and among businesses, government agencies and individuals, there are many aspects to the procurement process. The term “procurement” is used herein to refer to all aspects of the purchasing life cycle, including management of contracts, grants and cooperative agreements, interagency or interdepartmental agreements, master agreements, and other standard methods of procuring goods and services. Computer systems that support typically include systems directed to developing policies or regulations for the agreements, budgeting for products or services covered by the contracts, creating and monitoring the contracts, purchasing goods and services under the contracts, etc. The policy development and contract creation systems are typically little more than word processing systems. Budgeting, paying and monitoring funds spent are typically part of financial systems, including accounts payable systems, that have little information about the details of the contracts or procurement activity. Individuals in purchasing or procurement departments (who will be termed “procurement personnel”), particularly in large organizations, typically do not have an integrated view of all procurement-related information and documentation in the organization.

Furthermore, procurement management systems are typically not designed to include some types of contractual relationships that exist between organizations. The term “contractual relationships” as used herein refers to more than just conventional purchasing agreements. For example, many large businesses and governments use interdepartmental or interagency agreements in which costs are charged against and credited toward the budgets of the involved departments or agencies. Several government agencies also need to manage grants of funds to other organizations or individuals. Conventional purchasing systems typically do not handle these other kinds of agreements well. Existing systems that handle these functions are isolated systems for accomplishing a specific function (e.g., grant management or contract document generation). These existing systems are not integrated with a comprehensive core procurement system and fail to capture the full range of data elements required for comprehensive procurement data reporting.

Since federal government agencies have all of the types of agreements discussed above, most of the examples used below will be in the federal government sector. However, as noted above, many of the same problems exist in systems used by large businesses and in state and local governments. The term “agency” should be understood as including commercial, government and nonprofit organizations.

Processing federal procurements from initiation of a requisition through award, management, and close-out has historically been a paper-intensive process. Documents including requisitions, routing slips, approval sheets, solicitations, and contracts are needed to maintain a record of the procurement process and formally obligate the government to a purchase.

By the late 1980s, computer software products had been developed to help automate the federal procurement process. To a large extent, these products focused on support for specific aspects of the federal procurement process. For example, one system might provide online access to the Federal Acquisition Regulations (FAR), but it typically would not maintain a complete electronic file of contracts written using FAR clauses. Another system might support submission and receipt of vendor quotes, but it might not integrate FAR clauses. Many of these systems executed in text-based operating environments such as the Disk Operating System used by conventional personal computers.

In the 1990s, American Management Systems developed Procurement Desktop™ to provide comprehensive support for the procurement professional using state-of-the-art client/server and Microsoft® Windows® technology. Procurement Desktop™ automated all phases of the procurement process within a complete workflow management solution. It performed the total range of transactions and functions within such core procurement activities as requisitioning, approval routing, solicitations, and contract award and maintenance. In addition, select requisitioning functions via the Internet were made possible by PDWeb™ to facilitate creation of requests and viewing of requisition status.

While Procurement Desktop™ and other purchasing systems may provide comprehensive support for the procurement professional, many business processes that extend beyond the procurement department and outside of the procuring agency, are not supported. Within the procuring agency itself other staff members who are not part of the purchasing or procurement department may have important management roles in the procurement management process. They are “non-procurement personnel”, such as program staff, finance staff, property staff, receiving staff, and approving officials (e.g., department executives, legal counsel, small business advocates, information technology staff ). In addition, warrant authority and credit cards are increasingly distributed to program staff in the field who do not use the same systems as procurement office staff. It is often impossible, difficult or not cost effective to install and maintain a robust procurement application such as Procurement Desktop™ on the personal computers of each individual involved in the purchasing or procurement process.

In addition, the procurement process involves many parties that exist outside the procuring agency. For example, Small Business Administration officials are involved in approving certain small business program contracts. These parties that exist outside the procuring agency, but who are involved in the agency's procurement process will be termed “non-agency personnel” They are also included in the term “non-procurement personnel” regardless of their role at their agency or company, because they do not work at the procuring agency.

An agency may negotiate an interagency agreement with another agency, or a grant with a state or local government or an educational institution. In addition, the procuring agency may want to place an order against a contract established by another federal agency, e.g., General Services Administration (GSA) schedules. Agencies are also increasingly communicating with vendors electronically for both ordering and to monitor past performance activities. Vendors and other entities that may enter into contractual relationships with the procuring agency, including vendors, state and local governments, educational institutions, and independent contractors will be termed “prime and subcontractors”. These individuals of course are also “non-procurement personnel.” For several reasons ranging from security to software licensing, it is neither feasible nor desirable to install a comprehensive procurement system like Procurement Desktop™ software for use by non-agency personnel or prime and subcontractors to fully support the procurement management process.

Procuring agencies are also responsible for monitoring and managing all procurement activity. Managers of U.S. government agencies need to report to department executives, the Federal Procurement Data System, Congress, and other entities on how taxpayers' dollars are being spent. Similarly, managers in private industry report to higher level managers, owners, the board of directors, auditors, etc. The need exists to provide a cost-effective tool to enable a procurement office to conduct a wide range of purchasing activities, empower each participant in the process to contribute relevant data, maintain security over sensitive data, and generate comprehensive reports.

### SUMMARY OF THE INVENTION

It is an object of the present invention to apply the latest networking, database, communications, security and portable computer technology to expand access to procurement systems to meet the diverse procurement management needs of large organizations.

It is another object of the present invention to integrate existing systems related to the procurement process, including financial, accounts payable, human resources, budgeting inventory and reference material of regulations governing contracting, for collaborative use by all parties and personnel involved.

It is a further object of the present invention to provide a system for managing a variety of types of agreements defining contractual relationships between parties, including grants, cooperative agreements and interagency agreements.

It is yet another object of the present invention to provide a system supporting solicitation posting and bid receipt via a public computer network, including integration with standard systems for posting available procurement opportunities.

It is a yet further object of the present invention to provide an integrated procurement system accessible within security controls by geographically and organizationally diverse users using a public computer network.

It is yet another object of the present invention to provide a system supporting enterprise-wide contract vehicle ordering.

It is a yet further object of the present invention to provide a procurement management system that provides for acquisition planning.

It is yet another object of the present invention to provide a procurement management system that provides for vendor relationship management and acquisition action notification.

The above objects can be attained by storing reference data related to contractual relationships to be managed; storing agreement data relating to specific contractual relationships; and providing access, via a public computer network, to the agreement data and the reference data by all parties to the agreements in accordance with security procedures regarding what data can be accessed by each party. One of the parties controls the storing of agreement data and who obtains access and how much access is permitted. When the party with control is a procuring agency or department in a large organization, preferably other agencies or departments in the organization are provided access, in accordance with security procedures regarding what data can be accessed, to permit the other departments to purchase goods and services using at least one of the contracts negotiated by the procuring agency, and to perform a range of procurement management duties, including approval of purchases and receipt of goods. Also, the reference data preferably includes regulations governing the contractual relationships, required data elements in the agreements between the parties and standard sources of reference information related to the contractual relationships.

A method according to the present invention preferably further includes storing planning information related to planned purchases; storing actual purchasing data; comparing the acquisition planning information with the actual purchasing data for a given time frame; and making mid-plan adjustments in response to user input. Preferably the method also includes automatically generating notification of pending contract management actions based on the agreement data and reference data.

An integrated computer system used to attain the above objects includes a core procurement system used by procurement personnel in at least one procurement office; at least one application server, coupled to the core procurement system, providing access to the core procurement system by non-procurement personnel at the procuring agency, non-agency personnel, and prime and subcontractors, based on a security profile for each; and remote computers, coupled to the core procurement system by the at least one application server and a public computer network, executing thin-client software to access the core procurement system as permitted by the at least one application server. Preferably, the integrated computer system further includes at least one dictionary computer system, coupled to the core procurement system by the at least one application server and the public computer network, storing template definitions for documents and data entry screens in a self-describing document format, such as XML. Preferably, the remote computers transmit data to the core procurement system in the self-describing document format, based on at least the required data elements in the documents displayed by the remote computers after retrieval from the at least one reference computer system. In addition, the remote computers may include portable devices, each storing a warrant profile of a user carrying the portable device and purchasing data obtained and stored at point and time of sale. The portable devices perform a security check against the warrant profile to ensure purchases are at least one of within authorized dollar thresholds and for appropriate products or services

These together with other objects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a block diagram of a prior art core procurement system.

FIG. 2 is an integrated computer system according to the present invention.

FIGS. 3A-3B is a listing of tables associated with procurement documents.

FIG. 4 is a listing of tables associated with workflow functions.

FIG. 5 is a listing of tables associated with internal user characteristics.

FIG. 6 is a listing of tables associated with vendor characteristics.

FIG. 7 is a listing of tables associated with business rules.

FIG. 8 is a listing of tables associated with reference materials.

### DESCRIPTION OF THE PREFERRED EMBODIMENTS

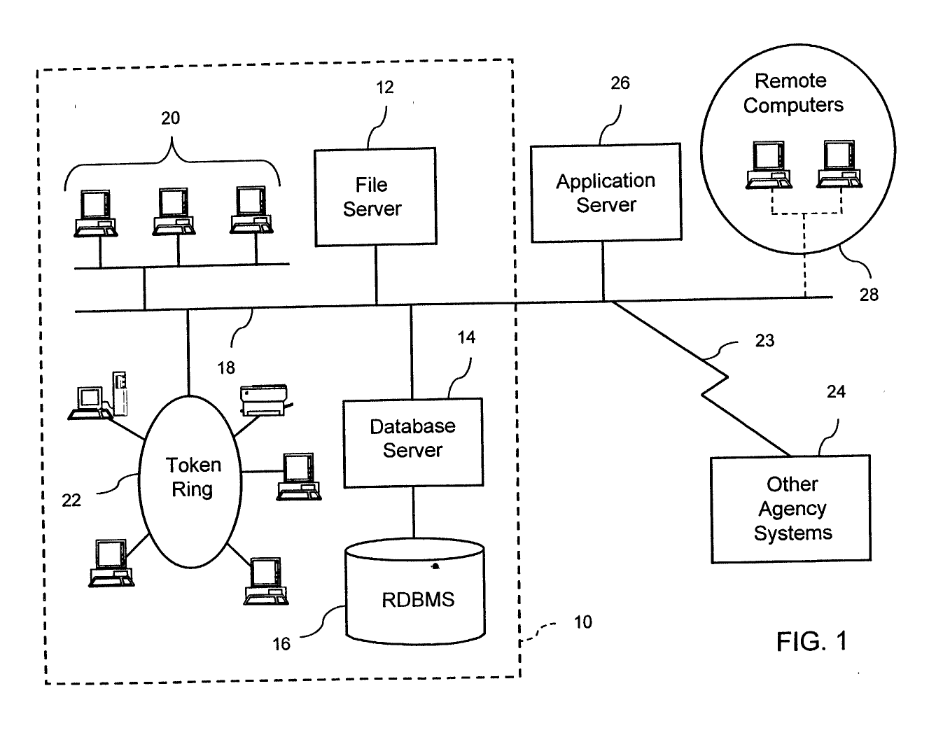

Illustrated in FIG. 1 is a block diagram of a conventional procurement system, Procurement Desktop™ with a PDWeb™ component under the control of a federal government agency that will be referred to as the procuring agency. As noted above, the core procurement system could be under the control of a department in a large corporation, in a state or local government or in any other large organization, all of which should be understood as being included within the definition of “procuring agency”. Core procurement system 10 illustrated in FIG. 1 includes file server 12 and database server 14 which provides access to a relational database management system (RDBMS) 16 connected by a local area network (LAN) 18. Procurement professionals in the procuring agency access these servers 12, 14 via LAN 18 and personal computers (PCs) or workstations 20 executing, e.g., Microsoft™ Windows™. Additional users may be connected by other networks, as represented by Token Ring network 22. Core procurement system 10 may be connected via an interface (represented by communication line 23) to other agency systems 24.

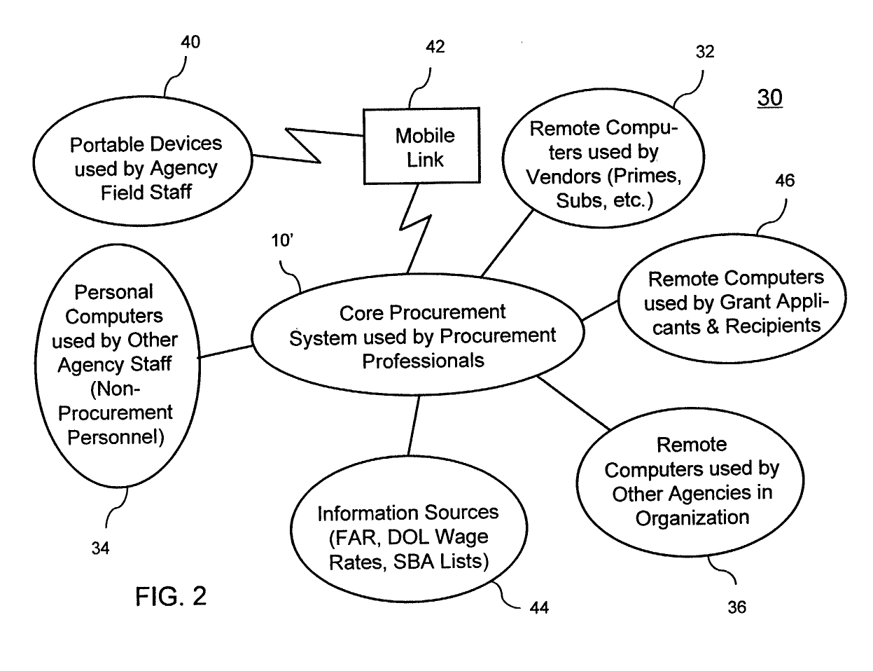

As illustrated in FIG. 2, an integrated system 30 according to the present invention has additional components connected to core procurement system 10′ via the Internet or other public computer network represented by the straight lines in FIG. 2. Furthermore, the capabilities of core procurement system 10′ are enhanced in a system according to the present invention. As described in more detail below, procurement professionals use core procurement system 10′ to create and modify agreement data related to specific contractual relationships, including contracts with vendors, interagency agreements, cooperative agreements, grants and any other contractual relationships that the procuring agency wishes to monitor using integrated system 30.

The additional components 32-46 illustrated in FIG. 2 provide access to more information by the procurement professionals served by core procurement system 10 and access by additional users who previously did not have access to core procurement system 10. Application server 26 provides access to data in RDBMS 16 of core procurement system 10 by remote computers 28 via communication equipment (not shown separately) using conventional protocols, such as those used by World Wide Web servers. Although illustrated and described as individual systems, depending on the size of the organization, file server 12, database server 14 and application server 26 may be a single computer system or a plurality of networked computer systems, including systems distributed locally or globally. Procurement personnel in the agency's procurement office use PCs 20, 22 in core procurement system 10 to access RDBMS 16 via the agency's LAN 18. They perform everyday procurement activities, such as generating solicitations, negotiating and modifying contracts, etc. As described below in more detail, procurement documents can be routed to appropriate individuals, such as vendors 32 using transactions in the core procurement system database 16 that change secure ownership of the documents from procurement personnel to the receiving individual. Access to documents is governed by the user identifier (user ID) and password and the security rights granted to that user. They may also transmit information from core procurement system 10 to other agency systems 24, such as the agency's financial system.

Routing of documents occurs when the database, at the direction of a party involved in the procurement process, transfers ownership of a document or package of documents from one party to another. This routing results in the document or package of documents being removed from the electronic desktop of the sending party and being delivered to the electronic desktop of the receiving party, whose ability to read, write to or delete the routed document(s) would be determined by the receiving party's security profile. The security profile for each party is governed based on database settings in core procurement system database server 14. These settings include determinations of access to procurement documents, procurement data, and vendor data, as well as determinations of an individual's authority to apply specific approvals to documents and warrant dollar thresholds, among other profile data for an individual or group of individuals. Access to documents by procurement personnel is governed by the user identifier (user ID) and password and the security rights granted to that user. Access to documents by non-procurement personnel at the procuring agency, non-agency personnel, and prime and subcontractors is governed by individual digital certificates. Procurement personnel use enhanced functions in core procurement system 10, added to the conventional procurement system, to access comprehensive procurement management data stored in RDBMS 16 of core procurement system 10 and to generate related reports.

As noted above, peripheral parties involved in the procurement management process, i.e., non-procurement personnel, include the vendors 32, grant applicants and recipients 46, other agency personnel 34 and non-agency personnel 36 in the same organization, as illustrated in FIG. 2. In the presently preferred embodiment, these non-procurement personnel preferably use an industry standard Web browser (e.g., Netscape Navigator, Microsoft Internet Explorer, etc.) executing thin-client software (e.g., Java applets) on remote computers 28 to log into database server 14 of core procurement system 10 using a digital certificate. Of course other communication protocols can be used today to provide access by remote users and it is expected that others will be developed in the future that are consistent with the present invention. To simplify the description below, reference will be made to Web browsers, Web access and other features of the World Wide Web, but the present invention may be implemented without use of the World Wide Web, e.g., by using proprietary communication and display software, although preferably industry-standard communication and display software is used.

The remote computers 28 obtain access to core procurement system database 16 via application server 26, a public computer network, such as the Internet, and the agency's LAN 18, so that the remote users can perform assigned procurement management activities. For example, documents and other data may be reviewed, consistent with the security profile corresponding to their user ID. Any data entered by the non-procurement personnel, such as approvals, other required federal data elements, etc., are transmitted to the procurement system database over the network connection. Self-describing document formats are preferably used to communicate business data among all parties involved in the procurement management process as described below. The self-describing document formats may use extensible markup language (XML) and document type definition (DTD) with extensible style sheet language (XSL) used to convert the XML formats to hypertext markup language (IITML), as supported by current versions of Microsoft® Internet Explorer and Netscape Navigator®. Any known variant of XML, such as Open Financial Exchange (OFX), Open Software Distribution (OSD) or Chemical Markup Language (CML) may be used.

Remote purchasing personnel also may be connected to core procurement system 10. A portable device 40 would be used by remote purchasing personnel to log procurement activities and submit purchase data to the core procurement system database 16. The portable device 40 may be implemented using smart cards and any conventional mobile computer, such as a notebook computer with a smart card reader, or by a hand-held or wearable computer to make “at-the-cashier” or field location commercial purchases, store and verify buyer warrant profiles, and gather purchase data at the point and time of sale or other transaction. Remote purchasing personnel use the portable device to transmit purchase data to core procurement system 10 via a mobile link 42, provided in a conventional manner by an Internet Service Provider, a satellite link, or other communications provider.

By using an integrated system 30 as illustrated in FIGS. 1 and 2, all parties involved in the procurement process have access to standard government information sources 44, such as Department of Labor wage rates, the Federal Acquisition Regulations, Small Business Administration lists of qualified small businesses, a list of Parties Excluded from Federal Procurement and Nonprocurement Programs, etc., using a Web browser executing on one of the remote computers 28 connected to the Internet. Web access to these resources is integrated into core procurement system 10 by the conventional process of analyzing requirements, preparing a design, and developing software.

Analyzing the requirements for a federal government agency includes analyzing federal procurement regulations to determine federal data elements that are required for managing and reporting on federal procurements and identifying standard government information sources like those described above. In the preferred embodiment, these regulations, rules and sources are encoded using XML to generate documents that can be interpreted by the client software executing on agency computers 20, 22 and remote computers 28 to format documents for display and can be interpreted by core procurement system 10 as data records defined by the self-describing data format and document template definitions, as described below.

Preparing the design includes analyzing the current state of the core procurement system, e.g., Procurement Desktop™ and PDWeb™, given the results of the requirements analysis and the available development tools. A detailed design for developing the invention is prepared and the design is reviewed with a software developer. The software developer develops and tests the enhancements to core procurement system 10 based on the design.

The result of the process described above are several modules that are added to conventional procurement systems like Procurement Desktop™ and PDWeb™. These modules are described in more detail below. For each of these components of the invention, a text description of the functionality is provided, as well as a high-level listing of the system modules and database tables that are used in implementing the component

One of the capabilities of integrated system 30 is enterprise-wide electronic catalog ordering. The integrated system 30 enables authorized buyers to place orders against available contract vehicles including master agreements and approved vendor electronic catalogs. Item data associated with the contract vehicles are linked with contract-level information stored in core procurement system 10. Products in the electronic catalog may be described or illustrated in supplemental files stored in RDBMS 16 or outside core procurement system 10 with links stored in RDBMS 16, so that the supplemental files can be displayed to a user. As another alternative, the information on the enterprise-wide electronic catalog could be stored in application server 26 or on another server. The goods or services available in an electronic catalog may include those purchased directly from another agency in the same organization, either directly by a providing agency, or on a contract that the providing agency has with an outside vendor. In the latter case, the data stored in core procurement system 10 may include a surcharge paid by the procuring agency to the providing agency. Functions provided by integrated system 30 to support government-wide electronic catalog ordering include:

(1) Searching for appropriate federal contract vehicles in preparation for placing an order. The search universe may include contracts and agreements negotiated within the procuring agency, as well as such other vehicles as GSA Schedule contracts, other agency contracts, vendor catalogs, or electronic malls (e.g., GSA Advantage). This function is accomplished by loading federal contract vehicle information onto application server 26 and permitting authorized parties to use a Web browser to access the contract vehicle information and narrow the universe of contract vehicles to those that meet common search criteria, such as commodity and industry codes that apply to the pending purchase.

(2) Searching the appropriate federal contract vehicle(s) for desired items. This includes the ability for authorized users to compare like items across available federal contract vehicles. In addition, integrated system 30 enables users to access additional detail about particular items, e.g., pictures, technical specifications, etc., from a variety of sources, such as the electronic catalog, manufacturer Web sites, etc. This function is accomplished by using the Web browser to navigate the list of items authorized for purchase, compare prices for like items from different contract vehicles, and access supporting documentation from the vendor that further describes the item to be purchased. This information is stored on database server 14, 16, application server 26 or accessed by connecting to the vendor's Web site over a public computer network, such as the Internet.

(3) Placing an order against a selected contract vehicle via the World Wide Web. The security procedures used include a security check against the buyer's warrant profile to ensure the purchase is within authorized dollar thresholds and for an appropriate product or service, e.g., checks against standard classification codes or agency-specific procurement tracking codes (e.g., custom vendor codes, geographic regions). Examples of standard classification codes are Federal Supply Codes, Standard Industrial Classification Codes, or North American Industrial Classification Codes for which the buyer is authorized to make purchases. In addition, this includes a check against federal contract vehicle(s) to reference appropriate terms, e.g., pricing, discounts, delivery options. This function is accomplished by performing automated comparisons of the data on a pending order, prepared via a connection to application server 26, with data stored on database server 14 regarding warrant dollar thresholds and commodity or industry codes that the individual is authorized to buy. If purchase is to be made by credit card, the security checks include whether the user is authorized to use the specified credit card for such a purchase.

(4) Communicating order information to the appropriate vendor. This includes a check against the vendor database to determine the appropriate method by which to send the order, e.g., Electronic Data Interchange (EDI), Electronic Data Interchange over the Internet (EDI/INT), Open Buying on the Internet (OBI), electronic mail, facsimile, etc. This function is accomplished by application server 26 performing a check against the vendor profile data stored on database server 14, 16 to verify the proper method of data transmission; determining the specific electronic address or fax number to which the order data needs to be transmitted; packaging the data, such as credit card, purchase order or other account information, in a compatible format to be transmitted in the medium specified by the vendor profile on database server 14, 16; and transmitting the data to a specified electronic address or fax number.

(5) Capturing purchase and funding information, e.g., federal budget citations associated with the profile of an order, vendor electronic funds transfer information, etc. and required procurement data elements, such as Federal Procurement Data System (FPDS) data, into core procurement system 10 as part of the purchase. This function is accomplished by application server 26 automatically associating FPDS reporting data elements from the contract vehicle, buyer profile, and the vendor profile with each order and prompting the buyer to enter data for any required FPDS data elements that are not known from the contract vehicle, buyer profile, and vendor profile data.

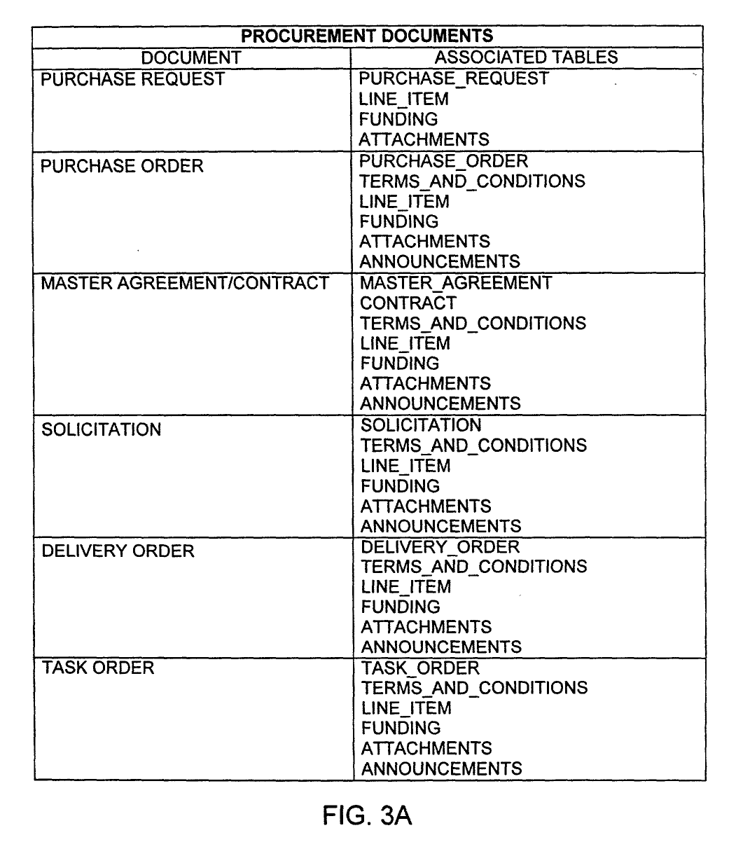

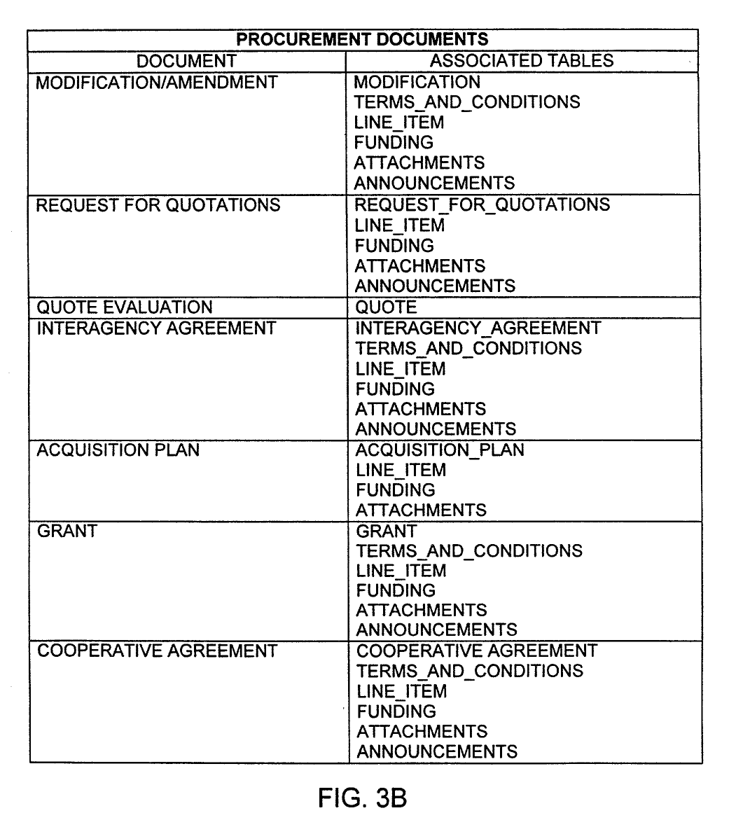

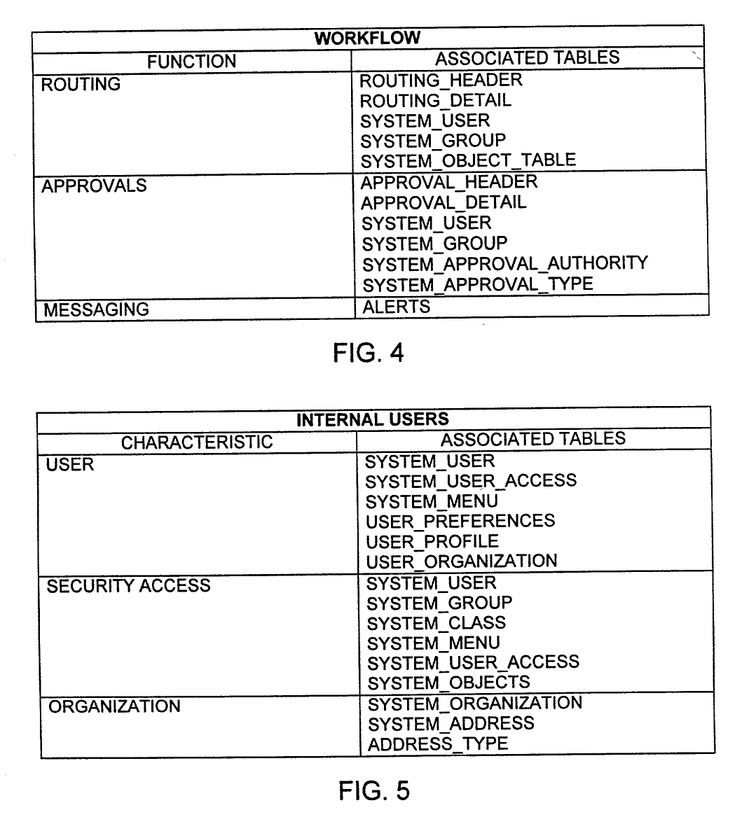

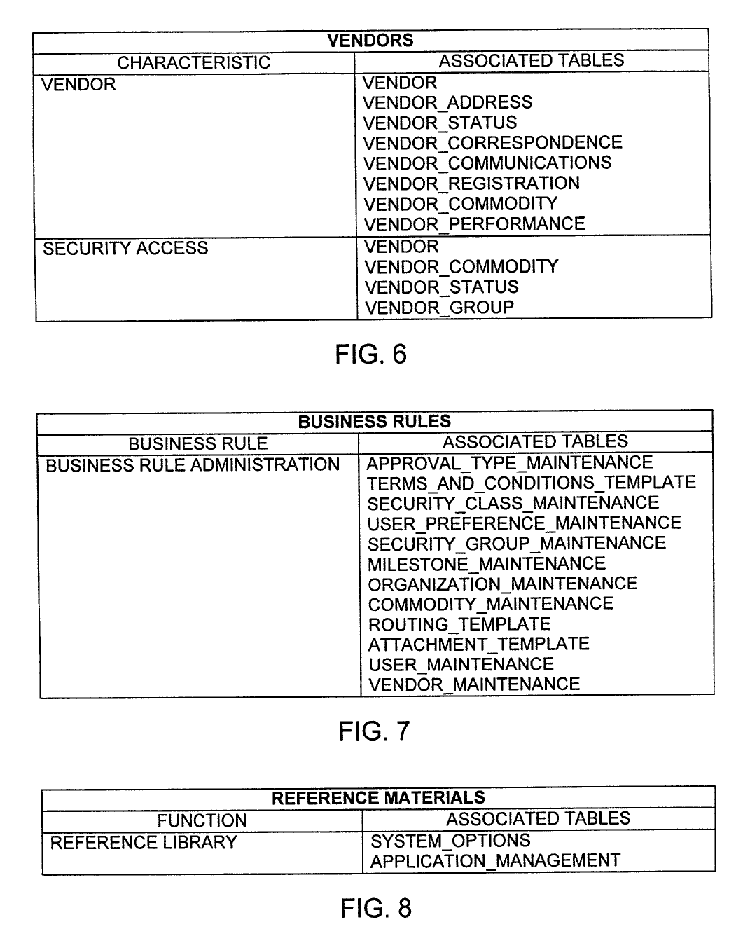

The following database-level modules are used in enterprise-wide electronic catalog ordering. Details of the database structure are provided in FIGS. 3A-8.

Procurement Documents: Purchase Request, Purchase Order, Master Agreement/Contract, Interagency

Agreement, Delivery Order, Task Order, and Modification/Amendment

Workflow: Messaging

Internal Users: User, Security Access, Organization

Vendors: Vendor, Security Access

Business Rules: Business Rule Administration

Reference Materials: Reference Library

Another capability of integrated system 30 is Web-based solicitation posting and bid receipt for procurement personnel to post solicitation documents created in core procurement system 10 to the World Wide Web and receive electronic bid responses from interested vendors. Any conventional solicitation posting vehicle may be used in conjunction with an integrated system according to the present invention. For example, a federal government agency might use the General Services Agency's planned Electronic Posting System. Functions provided by integrated system 30 to support Web-based solicitation posting and bid receipt may include:

(1) Posting announcements and notices of the availability of solicitations, completion of awards, and other procurement activities to a standard public vehicle, such as the Commerce Business Daily or CBDNet. This function is accomplished by procurement personnel executing a process that accesses data elements of specific announcements or notices that are stored in database server 14, 16, and transfers that information to be displayed on the standard public vehicle. Prime contractors and subcontractors access the notices via a Web interface supported on application server 26 or the standard public notice posting vehicle and contact the procuring agency's designated point of contact by generating e-mail or other communication.

(2) Storing contact information received in response to the solicitation announcement. This function is accomplished by storing e-mail addresses, facsimile numbers, post office addresses, etc. in database server 14, 16 as the contact information is received in response to the solicitation announcement.

(3) Extracting solicitation information from core procurement system 10 and presenting the solicitation information in a format that can be viewed by interested vendors. This function is accomplished by procurement personnel executing a process that accesses data elements stored in database server 14, 16, of a specific solicitation they have prepared, and transferring the solicitation information to application server 26 for access by vendors, via application server 26 and a public computer network. Preferably the solicitation information, at least on application server 26, is presented to the vendors in a self-describing document format, such as that created using XML.

(4) Enabling vendors to access solicitation information, decide if they want to bid, and provide quotes and supporting information for solicited items, e.g., vendor “fill-ins”, representations and certifications. This function is accomplished by registering a secure user identifier (user ID) and password for each vendor via a user interface supported by application server 26. If contact information is stored as described in (2), the vendors who replied to the announcement will have the solicitation information sent directly to them. Vendors responding to the solicitation have their user ID and password information verified when entered via the user interface, then the vendor is prompted by available procurement opportunities and a mechanism is provided for the vendor to enter bid information via the user interface. In the preferred embodiment, the user interface is a Web interface using industry standard browsers operating on the remote computers 32 and a Web server provided by application server 26.

(5) Capturing vendor responses and summarizing them in core procurement system 10 for evaluation and award by procurement personnel. This function is accomplished by providing vendors a mechanism to submit bid information via application server 26 and database server 14 to RDBMS 16 in core procurement system 10. The bid information is stored in database fields that support quote evaluation and can be populated onto any resulting award documents.

(6) Providing notification of bid receipt and eventual award to all participating vendors and on a standard public vehicle, such as CBDNet. This function is accomplished by procurement personnel executing a process that accesses data elements of a specific award they have prepared and stored in database server 14, 16, performing a check against the vendor profile data stored on database server 14, 16 for each vendor who bid on the solicitation to verify the proper method of electronic transmission of award notifications, determining the specific electronic address or fax number to which the award data needs to be transmitted, packaging the data in a compatible format to be transmitted in the medium specified by the vendor profile on database server 14, 16, and transmitting the data to the specified electronic address or fax number.

The following database-level modules illustrated in FIGS. 3A-8 are used in Web-based solicitation posting and bid receipt.

Procurement Documents: Solicitation, Request for Quotations, Quote Evaluation, Purchase Order, Master Agreement/Contract, Delivery Order, Task Order, Modification/Amendment, Interagency Agreement, Grant, Cooperative Agreement

Workflow: Messaging

Internal Users: User, Security Access, Organization

Vendors: Vendor, Security Access

Business Rules: Business Rule Administration

Reference Materials: Reference Library

Another capability of integrated system 30 is collaborative procurement management using the World Wide Web of the Internet or another computer network (preferably accessible to the general public) to enable each party in the procurement process to access and enter management information. Integrated system 30 provides the capability to support functions performed outside the procurement office, including:

(1) Routing solicitation and contract documents to authorized officials.

Documents may include, but are not limited to, statements of work, solicitations, amendments, proposal evaluations, contracts, modifications, delivery and task orders, vendor correspondence, and vendor evaluations. Authorized officials may include, but are not limited to, program staff, finance staff, receiving staff, legal counsel, organization executives, small business advocates, budget officers, information technology managers, property officials, and other parties inside or outside the procuring agency. The system enables authorized officials to access and enter information related to the procurement action. This function is accomplished by routing the documents as described above.

(2) Capturing data and documents each party contributes to the process, including but not limited to approvals, comments, and entry of required federal data elements (e.g., budget citations). This data is stored in the core procurement system to support comprehensive reporting. The system applies self-describing document formats in XML as a vehicle to facilitate the open exchange of business data among all parties. This function is accomplished by establishing Web data entry interfaces that apply XML to prompt each party to enter approval verification data and other data, related to the procurement, that are required reporting data elements. Data entered into these self-describing document formats using XML are transmitted from application server 26 into database server 14 and hence to RDBMS 16 in core procurement system 10. Procurement personnel access the data within core procurement system 10 and use features available in a conventional procurement system to build award documents and generate reports based on the transmitted data.

(3) Integrating all data entered via the Web into a comprehensive procurement system for use in generating and managing federal awards and in preparing federal reports (e.g., FPDS, Congressional notifications). This function is accomplished by a process similar to that described in the preceding paragraph.

The database-level modules illustrated in FIGS. 3A-8 used for collaborative procurement management include:

Procurement Documents: Acquisition Plan, Purchase Request, Solicitation, Request for Quotations, Quote Evaluation, Purchase Order, Master Agreement/Contract, Delivery Order, Task Order, Modification/Amendment, Interagency Agreement, Grant, Cooperative Agreement

Workflow: Routing, Approvals, Messaging

Internal Users: User, Security Access, Organization

Vendors: Vendor, Security Access

Business Rules: Business Rule Administration

Reference Materials: Reference Library

As noted above, portable devices 40 help provide remote purchase management capability. Worldwide “at-the-cashier” or “in-the-field” purchasing information is supplied to core procurement system 10 by portable devices 40. Components of integrated system 30 used for remote purchase management capability include smart cards, any mobile computer (such as a notebook computer with a smartcard reader, or a hand-held or wearable computer), Java Virtual Machines, and Java applets to provide authorized federal purchasers with a system for managing day-to-day purchases. Procurement personnel distribute portable devices 40 to agency staff who are authorized to make purchases on behalf of the agency, and who often do not have access to at least a remote computer at the time of purchase. These agency staff will be termed “field buyers”.

Procurement personnel load buyer warrant profiles for each field buyer into the core procurement system into database fields on database server 14, 16. Field buyers download the profile data onto their portable devices 40 via mobile communications link 42 and application server 26. For “in-the-field” purchases where no point-of-sale system is available, field buyers enter purchase data and their authorization of the purchase directly into their portable device 40 which verifies the purchase terms against the field buyer's profile. For “at-the-cashier” purchases, the field buyer may download the purchase authorization from portable device 40 onto a smartcard, which the field buyer would use to process the cash register transaction with the vendor. If the transaction is accepted against the profile, the field buyer uses mobile communication link 42 to transmit the purchase data to application server 26, which in turn forwards the data to database server 14 of core procurement system 10. Procurement personnel use core procurement system 10 to access the field buyer purchase data for tracking purchases and generating required reports.

The remote purchase management capability includes the following functions.

(1) Establishing electronic acquisition warrant profiles for federal officials who are authorized to make purchases. The acquisition warrant profiles may include per purchase dollar limits, total purchase limits, associated funding codes from which money is used to pay for purchases, authorized categories of purchases based on standard commodity codes, etc.

(2) Loading the warrant profile onto a portable device that would maintain a record of the individual's warrant authority and purchase history.

(3) Executing day-to-day purchases through the use of a smartcard or other such tool that stores the individual's profile, checks all attempted purchases against the profile, and records purchase data.

(4) Distributing purchase funding to the appropriate federal funding codes (e.g., budget object class) and commodity codes (e.g., Federal Supply Code, Standard Industrial Classification Code, North American Industrial Classification Code).

(5) Communicating purchase data (e.g., item purchased, property control number, funding codes, and commodity codes) via satellite or the Internet to procurement, financial, budget, and property systems for comprehensive agency purchase tracking and federal reporting.

(6) Generating status and other reports (e.g., funds available, purchasing patterns) for each purchaser.

The database-level modules illustrated in FIGS. 3A-8 used for remote purchase management include:

Procurement Documents: Acquisition Plan, Purchase Order, Master Agreement/Contract, Delivery Order, Task Order, Modification/Amendment, Interagency Agreement, Grant, Cooperative Agreement

Workflow: Approvals, Messaging

Internal Users: User, Security Access, Organization

Vendors: Vendor, Security Access

Business Rules: Business Rule Administration

Another capability of integrated system 30 is grant and cooperative agreement management to support the entire life cycle of federal grants and cooperative agreements. These agreements may be with other government entities, e.g., state and local governments, or with educational or research institutions. When integrated system 30 is used by a federal agency, there should be compliance with appropriate federal guidelines, such as OMB Circular A-102, Grants and Cooperative Agreements with State and Local Governments. As discussed above the grants and cooperative agreements, like the other documents, have self-describing document formats using XML to facilitate communication of grant management data to any remote computer 28 that has a connection to the of World Wide Web and uses an industry-standard browser capable of interpreting XML.

The grant and cooperative agreement functions of integrated system 30 include:

(1) Posting of availability notices. This function is accomplished by procurement personnel executing a process that accesses data elements of a specific grant or cooperative agreement opportunity that they have prepared and that has data stored in database server 14, 16, and transferring that information to be displayed by Web browsers connected via the public computer network to application server 26.

(2) Receipt of public comment on notices. This function is accomplished by registering a secure user identifier (user ID) and password for each commenter via a Web interface supported on application server 26, verifying the user ID and password information when entered via the Web interface, and prompting the commenter with data fields for entering comments in a document or data entry screen formatted using XML.

(3) Review by program, policy or OMB officials. This function is accomplished by establishing Web data entry interfaces that apply XML to prompt each party to enter approval verification data that are required reporting data elements for the grant or cooperative agreement. Data entered into these self-describing document formats are transmitted from application server 26 into RDBMS 16 by database server 14 in core procurement system 10. Procurement personnel access the data within core procurement system 10 and use features thereof to build grant and cooperative agreement documents and generate reports based on the transmitted data.

(4) Receipt of program narrative statements from applicants. This function is accomplished by providing applicants a mechanism to upload program narrative statements to application server 26 and subsequently into database server 14, 16 in core procurement system 10.

(5) Access to the List of Parties Excluded from Federal Procurement or Nonprocurement Programs included in information sources 44. This function is accomplished in a manner similar to accessing the Federal Acquisition Library, described below.

(6) Support for preapplications for construction, land acquisition, and land development projects. This function is accomplished by establishing Web data entry interfaces that apply XML to prompt potential applicants for required preapplication data. Data entered into these self-describing document formats are transmitted from application server 26 into database server 14, 16. Procurement personnel access the data within core procurement system 10 and use features of core procurement system to examine preapplication submissions.

(7) Notification of award adjustments, and automated adjustment of matching or cost sharing. This function is accomplished by procurement personnel executing a process that accesses data elements of a specific grant or cooperative agreement they have prepared that are stored in the database server, performing a check against the original award and any adjustments established by procurement personnel, performing a check against the vendor profile data stored on the database server for the awardee to verify the proper method of electronic transmission of award notifications, determining the specific electronic address or fax number to which the award data needs to be transmitted, packaging the data in a compatible format to be transmitted in the medium specified by the vendor profile on database server 14, 16, and transmitting the adjustment notification to the specified electronic address or fax number.

(8) Tracking of unobligated grant balances for carryover into subsequent grant periods. This function is accomplished by automated tracking of differences between the total grant or cooperative agreement balance and any obligations made for activities conducted under the grant or agreement, and by procurement personnel executing a function in core procurement system 10 to carryover any unobligated balance into subsequent grant periods.

(9) Support for cash management regarding transfer of funds or extending letters of credit. This function is accomplished by awardees entering electronic funds transfer (EFT) information and instructions as part of loading their vendor profile and by automatically transmitting EFT information from core procurement system 10 to the agency's financial system 24 for transfer of funds. Procurement personnel also enter data for letters of credit in core procurement system 10, which are accessible by awardees via the Web as allowed by security controls and procedures.

Grant applicants 46 may submit application data directly to core procurement system 10 using standard application forms formatted in XML, such as the following: SF 424, Facesheet; SF 424a, Budget Information (Non-Construction); SF424b, Standard Assurances (Non-Construction); SF 424c, Budget Information (Construction); and SF424d, Standard Assurances (Construction). Security clearance is not required, since the documents containing the application data are simply placed in an input queue for review by agency personnel. When grant applicants 46 become grant recipients, they obtain a secure user identifier (user ID) and password from the procuring agency and use the Web access provided by integrated system 30 to submit standard financial status report data to core procurement system 10 as XML documents using such standard report forms as: SF 269, Financial Status Report-Long Form; SF 269a, Financial Status Report-Short Form; SF 270, Request for Advance or Reimbursement; and SF 272, Report of Federal Cash Transactions.

Procurement personnel create grant and cooperative agreement awards in core procurement system 10, and generate reports on awards to categories of vendors based on data from awards entered into RDBMS 16 in core procurement system 10. Procurement personnel also enter award amounts made to specific categories of vendors, program income and credit data, data regarding the status of federally-owned assets used for the grant activity, any related award adjustments to account for the value of these assets, and cash paid. Awardees use the Web interface to enter required progress reports. Procurement personnel use the Web interface to enter data on site visit results. Procurement personnel use functions of the core procurement system to reconcile work plans with financial status reports, program progress reports, and payment status information.

The database-level modules illustrated in FIGS. 3A-8 used for grant application submission and grant monitoring include:

Procurement Documents: Acquisition Plan, Purchase Request, Solicitation, Quote Evaluation, Modification/Amendment, Grant, Cooperative Agreement

Workflow: Routing, Approvals, Messaging

Internal Users: User, Security Access, Organization

Vendors: Vendor, Security Access

Business Rules: Business Rule Administration

Reference Materials: Reference Library

As noted above, interagency or interdepartmental agreements are also supported by integrated system 30. The entire life cycle of interagency agreements is supported and integrated with core procurement system 10. In the case of a federal government agency, the system accesses information sources 44 to apply federal regulations and guidance regarding the operation of federal franchise organizations, Cooperative Administrative Support Units (CASUs), and other federally sanctioned entities to facilitate interagency, intragovernment procurement transactions. Documents in XML self-describing document formats are electronically transmitted to establish interagency agreements and transfer critical data elements, e.g., agency identifiers, electronic funds transfer codes, etc., among the agreeing parties.

The functions of integrated system 30 related to interagency and interdepartmental agreements include those performed both at an agency offering to provide products or services to other agencies and at an agency seeking to procure products or services through another agency. In the first case, where the procuring agency is offering services to other agencies (e.g., is acting as what will be termed a “source agency”), the procurement personnel execute a process that accesses data elements of specific advertisements or notices (similar to a Commerce Business Daily or CBDNet notice) that are stored in database server 14, 16, and transfers that information to be displayed on the public computer network by application server 26 or commonly used notice posting sources, such as CBDNet. The data elements posted include the e-mail address or other appropriate communications information, such as phone number and facsimile number. Other agencies access the notices via a Web interface supported on application server 26 or the commonly used notice posting source and contact the source agency's designated point of contact by generating an e-mail or other communication.

After the interested agency contacts the source agency, the system supports the creation, negotiation, and mutual completion of a Memorandum of Agreement (MOA) using self-describing XML document formats. This includes the source agency contact creating a draft MOA document in a self-describing XML document format on application server 26, posting the MOA in a secure environment on application server 26, establishing a user ID and password for the interested agency, and notifying the contact at the interested agency via e-mail or other communication of the availability of the MOA and how to access it, i.e., location of the Web site, the user ID and the password. The interested agency accesses the MOA via application server 26. The system verifies the user ID and password information and makes the MOA data available to the interested agency. The interested agency then enters appropriate MOA data for it's organization, e.g., funding citations, and submits the data in a self-describing document format to database server 14, 16 via application server 26. The source agency reviews the information and conducts negotiations as needed. When the MOA is ready, the source agency contact and other approving officials in the source agency accesses the MOA data in database server 14, 16 via application server 26 (or directly via core procurement system 10) to apply approvals. The interested agency applies and submits online approval of the MOA in a similar fashion.

In the second case, where the procuring organization is seeking interagency services from another agency, the process is handled as part of the solicitation posting, bid receipt, and award function described above, where the interagency service provider is treated like any other vendor. The one exception is that documents in self-describing XML document format are applied to support two-way communication of agreement data, e.g., funding citations, Memorandum of Agreement forms that both parties complete and approve, as described in the preceding two paragraphs.

Interagency agreements are recorded in core procurement system 10 of each agency that is a party to the agreement. Integrated system 30 enables tracking of agreements and inclusion of agreement data in procurement reports. This includes identifying agency vendors with appropriate federal reporting categories.

The database-level modules illustrated in FIGS. 3A-8 used for interagency and interdepartmental agreements include:

Procurement Documents: Acquisition Plan, Purchase Request, Solicitation, Request for Quotations, Quote Evaluation, Modification/Amendment, Interagency Agreement

Workflow: Routing, Approvals, Messaging

Internal Users: User, Security Access, Organization

Vendors: Vendor, Security Access

Business Rules: Business Rule Administration

Reference Materials: Reference Library

Preferably, acquisition planning is included in integrated system 30 to integrate acquisition planning information into core procurement system 10. Documents in XML self-describing document formats are used to exchange planning data that can be extracted by application server 26 and stored in core procurement system 10.

Program managers who are part of the procuring agency, but generally do not use core procurement system 10, use a Web browser interface to access web pages in self-describing XML document format via application server 26. These web pages prompt the program managers to enter data elements for an acquisition plan that defines what the manager needs to buy in the upcoming year, the budget citations, the finding required, etc. The managers enter the data using the Web interface and submit the data to application server 26, which updates acquisition plan data in RDBMS 16 of core procurement system 10. Authorized individuals access the acquisition plan data using a Web interface by logging in with a user ID and password, connecting to application server 26 and requesting the information. application server 26 retrieves the information from database server 14, 16 and formats it for display by Web browsers. These authorized individuals apply approvals to the acquisition plans as described above or conduct required research. The system controls this access using the security profile (including secure user ID and password) associated with the individual's user profile or a group of users.

During the time frame covered by the acquisition plan, procurement personnel create solicitation and award documents in core procurement system 10 which stores data in RDBMS 16 based on purchase requests submitted by program personnel. In addition, program staff make purchases themselves where they have the authority and submit the data to RDBMS 16 in core procurement system 10., as discussed above for purchases by a remote device. Authorized program personnel generate reports that compare actual or pending expenses against the relevant acquisition plan. These reports are generated by the person using a Web interface to connect to database server 14, 16 via application server 26 and retrieve acquisition plan and award information according to the person's security profile. A similar report is available to authorized procurement personnel directly via core procurement system 10. Authorized program managers have access from the Web interface to create a modification to the acquisition plan using data in self-describing XML document format. The manager enters and submits data for the modification using the same process as discussed for entering, submitting, and approving original acquisition plans. This includes support for changing, deleting, or canceling the plan.

The database-level modules illustrated in FIGS. 3A-8 used for acquisition planning include:

Procurement Documents: Acquisition Plan, Purchase Request, Solicitation, Request for Quotations, Purchase Order, Master Agreement/Contract, Delivery Order, Task Order, Modification/Amendment, Interagency Agreement, Grant, Cooperative Agreement

Workflow: Routing, Approvals, Messaging

Internal Users: User, Security Access, Organization

Business Rules: Business Rule Administration

Reference Materials: Reference Library

Vendor relationship management is also provided by integrated system 30. Functions that support vendor relationship management include:

(1) Registration of vendors, including the capturing of critical vendor data elements from, e.g., the vendor registration disclosure statement for federal government reporting using XML self-describing document formats. Vendors connect to the agency's or other organization's registry via the Web and register to do business with the organization. In addition to logging general vendor profile information, e.g., name, DUNS number, address, and contact, the system prompts vendors or vendor reviewers to associate the vendor with the appropriate reporting category or categories. Examples of federal reporting categories include those specified on the Federal Procurement Data System (FPDS) Summary Contract Action Report (Standard Form 281) and the FPDS Individual Contract Action Report (Standard Form 279). Data obtained from the vendor may include Contractor Identification Number, Principal Place of Performance, Type of Contractor (e.g., JWOD Nonprofit Agency, Small Disadvantaged Business), Preference Program (e.g., Buy Indian/Self-Determination, 8(a) Contract Award), Size of Small Business (i.e., number of employees or average annual gross revenue), and Type of Action (e.g., Domestic Outside U.S./Foreign).

(2) Reviewing vendors by entities outside the procuring agency. For example, Small Business Administration officials may connect via the Web to review data for vendors who are seeking contracts under SBA programs and determine if they qualify. This function is accomplished similarly to other approval processes described above.

(3) Entry of representations and certifications by vendors in response to solicitations, and incorporating that data as part of the electronic contract file. This includes cross-checking the representations and certifications with existing data in the vendor record. This function is accomplished by posting solicitation data on the Web using XML self-describing document formats. Vendors access the solicitations via the Web interface connected to application server 26. The document format prompts the vendors to enter quote information, as well as any other required information, including representations and certifications.

(4) Evaluation of vendor past performance by representatives of the procuring agency who work with the vendor after award, e.g., Contracting Officer's Technical Representative (COTR), using a Web interface to log vendor performance data, such as adherence to delivery schedule, quality of goods or services, level of satisfaction, etc. The COTR connects to application server 26 which retrieves from database server 14 basic information about the vendor and the contract/award for which the vendor's performance is being evaluated. The COTR is prompted to enter performance data into the self-describing document format, which is submitted to database server 14, 16 via application server 26. Vendors are also prompted from the Web interface to enter any comments on their past performance record.

(5) Secure distribution of vendor past performance information to authorized individuals. The security profiles and user IDs are used to provide vendors access only to their individual past performance record. Access to vendor performance data is controlled by the security profile for each user or group of users as stored in database server 14, 16, with important characteristics including the contract/award being evaluated, authorized personnel within the procuring agency, and parties outside the procuring agency. Authorized individuals access the past performance data via a Web interface or via core procurement system 10, similar to accessing reports.

(6) Management of prime and subcontractor relationships. This includes data entry and reports on prime and subcontractor activities for specific contracts using XML self-describing document formats to capture important data elements pertaining to a specific contract/award.

(7) Approval of bilateral agreements, e.g., contract modifications. This includes certification of approvals by vendors via the Web and capturing those certifications in core procurement system 10. This function is accomplished similarly to other approval processes discussed above.

The database-level modules illustrated in FIGS. 3A-8 used for vendor relationship management include:

Procurement Documents: Solicitation, Request for Quotations, Quote Evaluation, Purchase Order, Master Agreement/Contract, Delivery Order, Task Order, Modification/Amendment, Interagency Agreement, Grant, Cooperative Agreement

Workflow: Routing, Approvals, Messaging

Internal Users: User, Security Access, Organization

Vendors: Vendor, Security Access

Business Rules: Business Rule Administration

An acquisition action notification engine may be included in integrated system 30 to notify participants in the federal procurement management process of pending action items, such as approvals required. Notification messages may be “pushed” using conventional techniques, such as pop-up Web notices or e-mail, to appropriate federal or vendor representatives when procurement management actions are required. A message may notify the recipient that a federal procurement activity is awaiting action. These notifications are integrated with links to the Web-based federal procurement management system to perform the required activity, e.g., review a solicitation, evaluate a proposal, approve a bilateral agreement, etc.

The database-level modules illustrated in FIGS. 3A-8 used for acquisition action notification include:

Procurement Documents: Acquisition Plan, Purchase Request, Solicitation, Request for Quotations, Offer evaluation, Purchase Order, Master Agreement/Contract, Delivery Order, Task Order, Modification/Amendment, Interagency Agreement, Grant, Cooperative Agreement

Workflow: Routing, Approvals, Messaging

Internal Users: User, Security Access, Organization

Vendors: Vendor, Security Access

Business Rules: Business Rule Administration

Information sources 44 include a reference library of material used by both procurement and non-procurement personnel. When integrated system 30 is used by a federal agency, information sources 44 would preferably include current federal acquisition regulations, e.g., the Federal Acquisition Regulation, agency supplements and other standard government information sources, as described above. Documents stored in the reference library are in XML self-describing formats for easy access using industry-standard Web browsers. The reference library in information sources 44 supports generation of solicitation and contract documents using federal clauses and provisions and research of other acquisition documents via the Web, such as SBA small business information, Department of Labor wage rates, debarred vendor lists, and other standard government information resources.

Parties involved in the procurement management process use a Web interface to connect to information sources 44, e.g., an electronic library stored on a Web server. The Web server offers links to common acquisition information resources. These links either connect the individual with Web-based data sources maintained by outside parties, e.g., official DOL wage rate lists, SBA small business lists, debarred vendor lists, GSA resources such as GSA Advantage or Electronic Posting System, or display resources stored on the Web server, e.g., the FAR formatted in XML self-describing document format that is compatible with document generation functions of core procurement system 10 and agency-specific policies and regulations.

The following database-level modules are used to control access to the reference library:

Procurement Documents: Solicitation, Request for Quotations, Purchase Order, Master Agreement/Contract, Delivery Order, Task Order, Modification/Amendment, Interagency Agreement, Grant, Cooperative Agreement

Workflow: Messaging

Internal Users: User, Security Access, Organization

Vendors: Vendor, Security Access

Business Rules: Business Rule Administration

Reference Materials: Reference Library

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### Reference Number List

10 conventional core procurement system

10′ enhanced core procurement system

12 file server

14 database server

16 relational database management system (RDBMS)

18 local or wide area network (LAN/WAN)

20 personal computers (PCs) or workstations

22 subnetwork, such as token ring network

23 communication line

24 other agency systems

26 application server

28 remote computers

30 integrated system

32 remote computers used by vendors

34 personal computers used by other agency staff

36 remote computes used by non-agency personnel of the same organization

40 portable devices used by agency field staff

42 mobile link

44 information sources

What is claimed is:

1. An integrated computer system utilizing a public computer network, comprising:
a core procurement system used by procurement personnel in at least one procurement office;
at least one application server, coupled to said core procurement system, providing access to said core procurement system by procurement personnel and non-procurement personnel based on a security profile for each; and
remote computers, coupled to said core procurement system by said at least one application server and the public computer network, executing thin-client software to access said core procurement system as permitted by said at least one application server.

2. An integrated computer system as recited in claim 1, further comprising at least one reference computer system, coupled to said core procurement system by said at least one application server and the public computer network, providing access to procurement regulations, required data elements and standard sources of information to all users of said integrated computer system.

3. An integrated computer system as recited in claim 2,
further comprising at least one dictionary computer system, coupled to said core procurement system by said at least one application server and the public computer network, storing document template definitions for documents in a self-describing document format,
wherein each of said remote computers includes at least one display, and
wherein said at least one reference computer system stores the procurement regulations, the required data elements and the standard sources in the self-describing document format interpretable by the thin-client software executing on said remote computers to format the documents on the display and interpretable by said core procurement system as data records defined by the self-describing data format and the document template definitions.

4. An integrated computer system as recited in claim 3, wherein said remote computers transmit data to said core procurement system in the self-describing document format, based on at least the required data elements in the documents displayed by said remote computers after retrieval from said at least one reference computer system.

5. An integrated computer system as recited in claim 2, wherein said at least one reference computer system provides access to at least one of standard application forms and standard financial status report forms.

6. An integrated computer system as recited in claim 5, wherein said at least one reference computer system further provides access to at least one of Federal Acquisition Rules, Department of Labor Wage Rates, Small Business Administration lists of qualified small businesses, List of Parties Excluded from Federal Procurement and Nonprocurement Programs.

7. An integrated computer system as recited in claim 2,
further comprising desktop computers connected to said core procurement system,
wherein said core procurement system stores at least one of standard classification codes and agency-specific procurement tracking codes, and
wherein said remote computers and said desktop computers perform at least one of
a first security check against a warrant profile of an authorized buyer to ensure purchases are within at least one of authorized contract thresholds and buyer-specific dollar thresholds,
a second security check for appropriate goods and services by comparing with at least one of Federal Supply Codes, Standard Industrial Classification Codes, North American Industrial Classification Codes, and agency-defined codes for which the authorized buyer is authorized to make purchases, and
a third security check against at least one contract vehicle to reference appropriate terms, including at least one of pricing, discounts, and delivery options.

8. An integrated computer system as recited in claim 7, wherein said remote computers include portable devices, each coupled to said core procurement system via said at least one application server and storing the warrant profile of the authorized buyer carrying the portable device and purchasing data obtained and stored at point and time of sale, said portable devices performing the first, second and third security checks against the warrant profile and the at least one contract vehicle to reference appropriate terms.

9. An integrated computer system as recited in claim 8,
further comprising a mobile communication link coupled to said core procurement system, and
wherein said portable devices include a communication unit for communication with said core procurement system via said mobile communication link to transmit the purchasing data to said core procurement system.

10. An integrated computer system as recited in claim 1,
wherein said core procurement system is used by the procurement personnel of a procuring government agency, and
wherein said remote computer systems are used by at least one of the procurement personnel, the non-procurement personnel of the procuring government agency, prime contractors, subcontractors, grantees, higher education institutions, and other government agencies to receive and provide information related to agreements with the procuring government agency.

11. An integrated computer system as recited in claim 10,
wherein said at least one application server
stores contract vehicle information as an electronic catalog, searches the electronic catalog to compare entries in the electronic catalog and other product information available via the public computer network according to instructions from authorized parties connected via the public computer network,
checks vendor profiles for method of purchasing data transmission,
transmits vendor purchasing data to vendors to place orders, and
transfers purchasing data to said core procurement system to record budget information, vendor electronic funds transfer information and required procurement data elements, and
wherein said core procurement system
stores the vendor profiles of authorized vendors, the purchasing data and warrant profiles of authorized buyers,
performs a security check against the warrant profiles to ensure each purchase is within authorized dollar thresholds and for appropriate goods and services, and
checks the contract information for at least one of pricing, discounts and delivery options.

12. An integrated computer system as recited in claim 1,
wherein said core procurement system stores data related to grants of finds to at least one of individuals and organizations and the procurement personnel administer the grants,
wherein said integrated computer system further comprises at least one reference computer system, coupled to said core procurement system, providing access to information about and regulations governing the grants, and
wherein said remote computers are used by grantees of the grants to submit at least one of standard grant applications forms, monitor status of grant applications, submit standard financial status report forms, submit standard progress reports, and report on progress of other activities related to the grants.

13. An integrated computer system as recited in claim 12, wherein said at least one reference computer system stores the information about and regulations governing the grants in a self-describing document format.

14. A method of managing contractual relationships, comprising:
storing reference data related to contractual relationships to be managed;
storing agreement data relating to specific contractual relationships; and
providing access, via the public computer network, to the agreement data and the reference data by all parties to the agreements in accordance with security procedures regarding what data can be accessed by each party.

15. A method as recited in claim 14, wherein said storing of reference data includes storing regulations governing the contractual relationships, required data elements in the agreements between the parties and standard sources of reference information related to the contractual relationships.

16. A method as recited in claim 14, further comprising controlling the security procedures by at least one authorized procurement officer in a procuring agency establishing security access for all other users to the agreement data using security controls within a core procurement system operated by the procuring agency.

17. A method as recited in claim 16, wherein said controlling of the security procedures includes establishing security checks against vendor relationship profiles for prime and subcontractors, the vendor relationship profiles including at least one of contractor identifier, taxpayer identifier, preference program designation, size of business, geographic location, standard vendor category and grantee category.

18. A method as recited in claim 16, wherein said controlling of the security procedures for personnel of the procuring agency includes
establishing for authorized buyers, security checks against at least one of a warrant profile of an authorized buyer and appropriate terms of at least one contract vehicle,
establishing for the personnel who are not authorized buyers, security checks against at least one of approval authority and security group membership.

19. A method as recited in claim 16, wherein said controlling of the security procedures for non-agency personnel outside the procuring agency but part of an organization that includes the procuring agency, includes establishing security checks against at least one of type of contract, approval authority, and security group membership.

20. A method as recited in claim 19,
wherein the specific contractual relationships include contracts between the procuring agency and vendors of at least one of goods and services, and
wherein access is provided to the agreement data and the reference data by the non-agency personnel in accordance with the security procedures regarding what data can be accessed, to permit the non-agency personnel to purchase the at least one of goods and services using at least one of the contracts negotiated by the procuring agency.

21. A method as recited in claim 14, wherein the specific contractual relationships include at least one of
contracts between an agency outside the procuring agency and the vendors of at least one of goods and services that are available to the procuring agency as authorized contract vehicles,
publicly available vendor catalogs,
publicly available electronic malls,
agreements between the procuring agency and other agencies of an organization of which the procuring agency is a part, to provide at least one of goods and services, and
cooperative agreements between the procuring agency and at least one of educational institutions, state governments, local governments, and independent research institutions.

22. A method as recited in claim 21, further comprising placing orders directly from the electronic catalog for submission to a vendor by
comparing buyer profiles with purchase information to verify that both agency personnel and non-agency personnel requesting purchases are authorized buyers for the purchases and purchase limits are not exceeded;
retrieving account information from the buyer profiles;
transmitting the purchase information and the account information to the vendor; and
recording the purchase information, the account information and funding information in a database maintained by the procuring agency.

23. A method as recited in claim 16,
wherein the procuring agency is a government agency, and
wherein the specific contractual relationships include at least one grant from the government agency to another organization.

24. A method as recited in claim 14, further comprising:
storing acquisition planning information related to planned purchases, including at least one of program elements, budget object classes, and plan abstracts in a self-describing document format;
storing actual purchasing data;
comparing the acquisition planning information with the actual purchasing data for a given time frame; and
making mid-plan adjustments in response to user input, including at least one of changing, deleting, or canceling data included in the acquisition planning information.

25. A method as recited in claim 14, further comprising:
storing current vendor data obtained from current agreements between at least one of the parties to the agreements and vendors providing at least one of goods and services to the at least one of the parties;
storing vendor past performance data of the vendors;
storing contractor relationships between prime contractors and subcontractors included in the vendors; and
generating reports based on the current vendor data, the vendor past performance data and the contractor relationships.

26. A method as recited in claim 25,
wherein the contractual relationships include agreements between a procuring agency and the vendors, and
wherein said method further comprises:
capturing vendor relationship profile data including at least one of data elements specified on a Federal Procurement Data System Summary Contract Action Report, a Federal Procurement Data System Individual Contract Action Report, a DUNS number, and a taxpayer identifier;
reviewing vendor qualifications by other agencies outside the procuring agency where the other agencies have review authority over federal contract programs, including at least Small Business Administration contract programs; and
approving bilateral agreements by the vendors in cases where vendor approval is required to finalize the specific contractual relationships.

27. A method as recited in claim 14,
wherein said storing of at least the agreement data is performed at least in part by a core procurement system, and
wherein said method further comprises automatically notifying at least one system user about at least one of system alerts, electronic messages and approaching contract management milestone events via at least one of remote computers and portable devices connected to an application server, and desktop computers connected to the core procurement system.

28. A method as recited in claim 14, wherein said storing of the reference data includes storing document template definitions for documents in a selfdescribing document format.

29. A method as recited in claim 28, wherein the reference data includes Federal Acquisition Regulations using the self-describing document format.

30. A method of managing procurement activities for a government, comprising:
placing orders against government contract vehicles;
distributing solicitation and contract documents to authorized officials;
capturing required government procurement data elements as part of the contracting process;
capturing data from and exerting management controls over remote purchases; and
managing vendor relationships.

31. A method as recited in claim 30,
wherein the government procurement data elements captured as part of the contracting process and the data captured from remote purchases are stored in a core procurement system, and
wherein said managing of the vendor relationships includes
storing vendor management data in vendor relationship profiles in the core procurement system;
extracting solicitation information from the core procurement system and presenting it to prospective vendors via a public computer network;
establishing a self-describing document format for vendors to access the solicitation information and submit at least one of related quotes, proposals, representations, and certifications;
cross-checking at least one of vendor bid and proposal data submissions with data in the vendor relationship profiles;
evaluating past performance of the vendors;
capturing data from vendor solicitation responses in the core procurement system for evaluation and award by procurement personnel; and
notifying participating vendors of bid receipt and eventual award.

32. A method as recited in claim 30, further comprising at least one of managing grants and cooperative agreements;
executing interagency agreements; and
developing, monitoring and managing acquisition plans.

33. A method as recited in claim 30, further comprising:
exchanging business documents associated with orders;
checking inventory;
monitoring status of contracts with vendors;
checking logistics information; and
checking tax information.

34. A computer program embodied on a computer readable medium, comprising:
storing reference data related to contractual relationships to be managed;
storing agreement data relating to specific contractual relationships; and
providing access, via the public computer network, to the agreement data and the reference data by all parties to the agreements in accordance with security procedures regarding what data can be accessed by each party.

35. A computer program as recited in claim 34, further comprising extracting solicitation information in a self-describing document format;
providing access by vendors to the solicitation information in the self-describing document format;
capturing data from vendor solicitation responses for evaluation and award by procurement personnel; and
notifying participating vendors of bid receipt and eventual award.
